(19) United States
(12) Patent Application Publication
(10) Pub. No.: US 2016/0156093 A1
(43) Pub. Date: Jun. 2, 2016

(54) ANTENNA STRUCTURE AND WIRELESS COMMUNICATION DEVICE USING SAME

(71) Applicant: FIH (HONG KONG) LIMITED, Kowloon (HK)

(72) Inventors: CHUAN-CHOU CHI, New Taipei (TW); CHENG-HUNG KO, New Taipei (TW); HAO-YING CHANG, New Taipei (TW)

(21) Appl. No.: 14/591,163

(22) Filed: Jan. 7, 2015

(30) Foreign Application Priority Data
Nov. 28, 2014 (TW) 103141307

(51) Int. Cl. H01Q 1/24

(52) U.S. Cl. CPC H01Q 1/243

(57) ABSTRACT

An antenna structure includes an antenna holder, a first metallic portion, a second metallic portion, and a radiator. The antenna holder includes a top wall, a first sidewall, and a second sidewall. The first sidewall and the second sidewall are both substantially perpendicularly connected to a periphery of the top wall. The radiator is positioned at least on the top wall, the first sidewall, and the second sidewall. The first metallic portion is substantially parallel to the first sidewall. The second metallic portion is substantially parallel to the second sidewall. The first metallic portion and the second metallic portion are both configured for being coupled to the radiator.

### CROSS-REFERENCE TO RELATED APPLICATIONS

This application claims priority to Taiwanese Patent Application No. 103141307 filed on Nov. 28, 2014, the contents of which are incorporated by reference herein.

### FIELD

The subject matter herein generally relates to an antenna structure and a wireless communication device using the antenna structure.

### BACKGROUND

Antennas are important elements of wireless communication devices, such as mobile phones or personal digital assistants. Many wireless communication devices further employ metal housings for improving heat dissipation or other purposes.

### BRIEF DESCRIPTION OF THE DRAWINGS

Implementations of the present technology will now be described, by way of example only, with reference to the attached figures.

FIG. 1 is an exploded, isometric view of an embodiment of a wireless communication device employing an antenna structure.

FIG. 2 is an assembled, isometric view of the wireless communication device of FIG. 1.

FIG. 3 is a diagrammatic view of the wireless communication device of FIG. 2.

FIG. 4 is a return loss (RL) graph of the antenna structure of the wireless communication device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

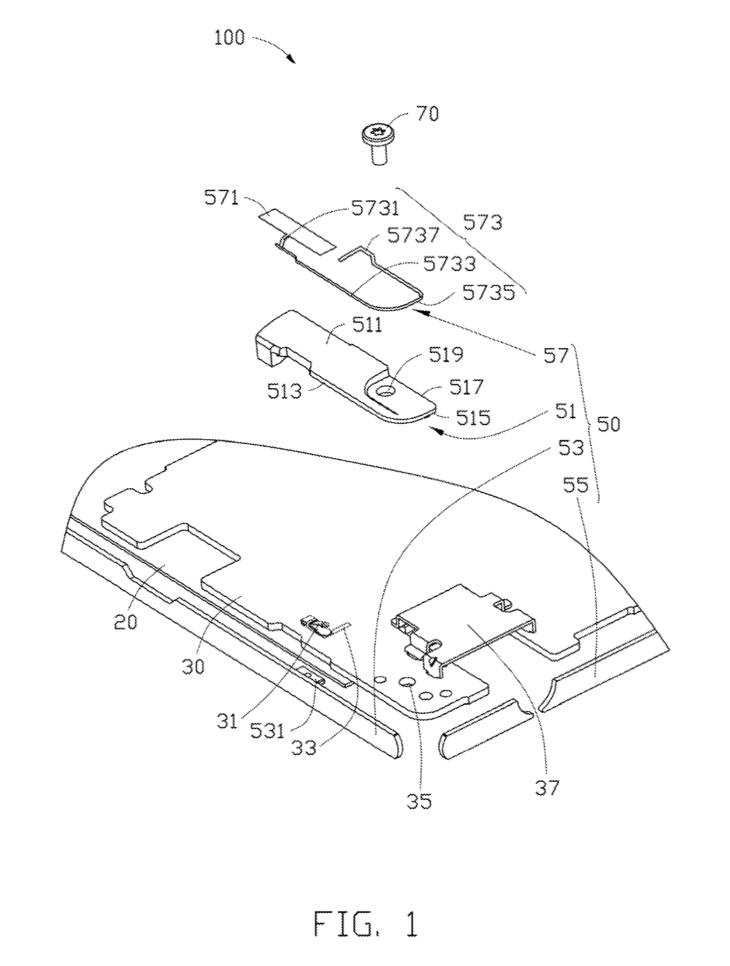

FIG. 1 illustrates an embodiment of a wireless communication device 100. The wireless communication device 100 can be a mobile phone or a personal digital assistant, for example. The wireless communication device 100 includes a baseboard 20, a circuit board 30, and an antenna structure 50.

In this embodiment, the baseboard 20 can be made of metal material. The circuit board 30 is positioned on the baseboard 20. The circuit board 30 forms a feed point 31, a ground point 33, a mounting hole 35, and an electronic element 37. In this embodiment, the feed point 31 is metallic shrapnel and is configured to feed current to the antenna structure 50. The ground point 33 is configured to ground the antenna structure 50. The ground point 33 is further electrically connected to the feed point 31.

That is, the feed point 31 and the ground point 33 share the same metallic shrapnel. The mounting hole 35 is configured to mount the antenna structure 50 to the circuit board 30. In this embodiment, the electronic element 37 is a connector. The electronic element 37 is located at one end of the circuit board 30 adjacent to the mounting hole 35.

The antenna structure 50 includes an antenna holder 51, a first metallic portion 53, a second metallic portion 55, and a radiator 57. The antenna holder 51 is substantially frame-shaped and includes a top wall 511, a first sidewall 513, a second sidewall 515, and a third sidewall 517. An assembling hole 519 is defined at the top wall 511. The antenna holder 51 can be assembled to the circuit board 30 via a mounting element 70, for example, a screw or the like, inserting through the assembling hole 519 and the mounting hole 35.

The first sidewall 513 is parallel to and spaced apart from the third sidewall 517. The second sidewall 515 has two ends respectively connected to the first sidewall 513 and the third sidewall 517. In this embodiment, the antenna holder 51 is positioned on the circuit board 30 with the third sidewall 517 adjacent to the electronic element 37.

The first sidewall 513, the second sidewall 515, and the third sidewall 517 are all perpendicularly connected to a periphery of the top wall 511. Then, the first sidewall 513, the second sidewall 515, the third sidewall 517, and the top wall 511 cooperatively form a receiving space (not labeled). The receiving space is configured to receive the feed point 31 and the ground point 33 when the antenna holder 51 is positioned on the circuit board 30. In this embodiment, the receiving space has a size of about 18.8 mm×4.2 mm×1.4 mm.

The first metallic portion 53 and the second metallic portion 55 can be both a portion of a metallic housing of the wireless communication device 100, or can be a decorative metallic strip of the wireless communication device 100. The first metallic portion 53 is spaced apart from one side of the circuit board 30 and is substantially parallel to the first sidewall 513 of the antenna holder 51. The second metallic portion 55 is substantially perpendicular to the first metallic portion 53. The second metallic portion 55 is spaced apart from another side of the circuit board 30 and is substantially parallel to the second sidewall 515 of the antenna holder 51. In this embodiment, a distance between the first metallic portion 53 and the first sidewall 513 is about 2.3 mm. A distance between the second metallic portion 55 and the second sidewall 515 is about 2.3 mm. One side of the first metallic portion 53 facing to the first sidewall 513 further forms a ground portion 531 for grounding the first metallic portion 53.

In this embodiment, the radiator 57 is a global positioning system (GPS) antenna and is formed by laser technology. The radiator 57 includes a feed portion 571 and a radiating portion 573. The feed portion 571 is substantially a rectangular sheet. The feed portion 571 is located in the receiving space and resists the feed point 31. Then, the feed portion 571 is electrically connected to the feed point 31 and is configured to feed current from the feed point 31 to the radiator 57.

The radiating portion 573 is electrically connected to the feed portion 571 and forms a substantially loop structure with the feed portion 571. The radiating portion 573 includes a connecting section 5731, a first radiating section 5733, a second radiating section 5735, and a third radiating section 5737. The connecting section 5731 is substantially arc-shaped and is electrically connected to one side of the feed portion 571.

The first radiating section 5733 is positioned at the first sidewall 513. In this embodiment, the first radiating section 5733 is substantially a strip. One end of the first radiating section 5733 is electrically connected to one end of the connecting section 5731 away from the feed portion 571. The other end of the first radiating section 5733 extends along a direction towards the second metallic portion 55. The first radiating section 5733 is parallel to the first metallic portion 53.

The second radiating section 5735 is positioned at the second sidewall 515. In this embodiment, the second radiating section 5735 is substantially a strip. One end of the second radiating section 5735 is electrically connected to one end of the first radiating section 5733 away from the connecting section 5731. The other end of the second radiating section 5735 extends along a direction away from the first metallic portion 53. The second radiating section 5735 is parallel to the second metallic portion 55. The third radiating section 5737 is substantially a meandering sheet and is positioned on one side of the top wall 511 adjacent to the third sidewall 517. The third radiating section 5737 is further electronically connected to one end of the second radiating section 5735 away from the first radiating section 5733. In other embodiments, a shape and/or structure of the radiating portion 573 can be adjusted according to a shape of the antenna holder 51.

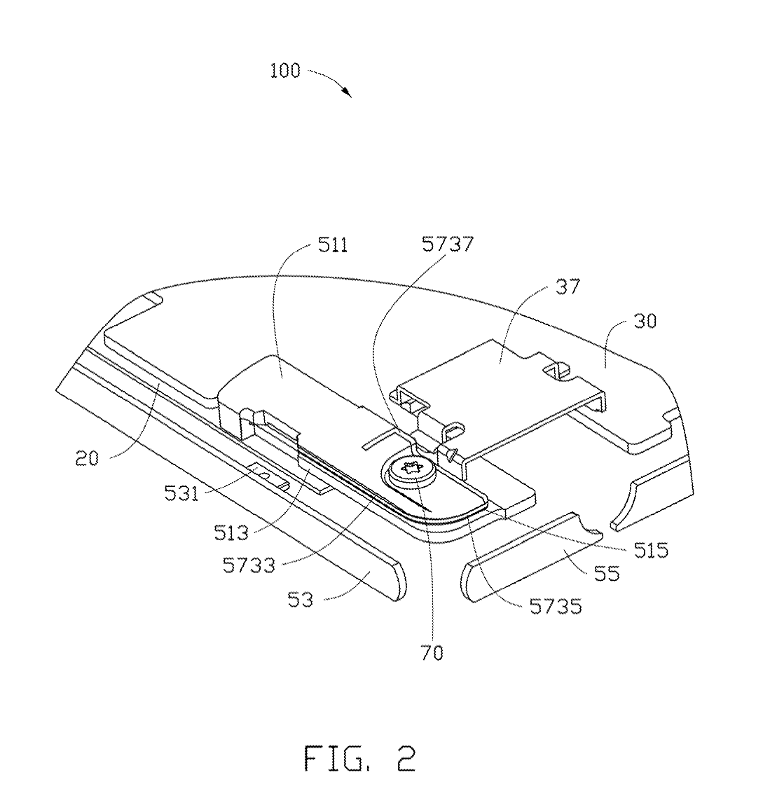

Referring to FIG. 2, in assembly, the feed portion 571 of the radiator 57 and the connecting section 5731 are both received in the receiving space. The feed portion 571 abuts against the feed point 31 so as to be electrically connected to the feed point 31 for feeding current to the radiator 57. The first radiating section 5733 is positioned on the first sidewall 513, the second radiating section 5735 is positioned on the second sidewall 515, and the third radiating section 5737 is positioned on the top wall 511 of the antenna holder 51. The antenna holder 51 is positioned on the circuit board 30 with the assembling hole 519 aligned with the mounting hole 35. The mounting element 70, for example, a screw or the like, is inserted through the assembling hole 519 and the mounting hole 35 so that the antenna holder 51 with the radiator 57 is assembled to the circuit board 30.

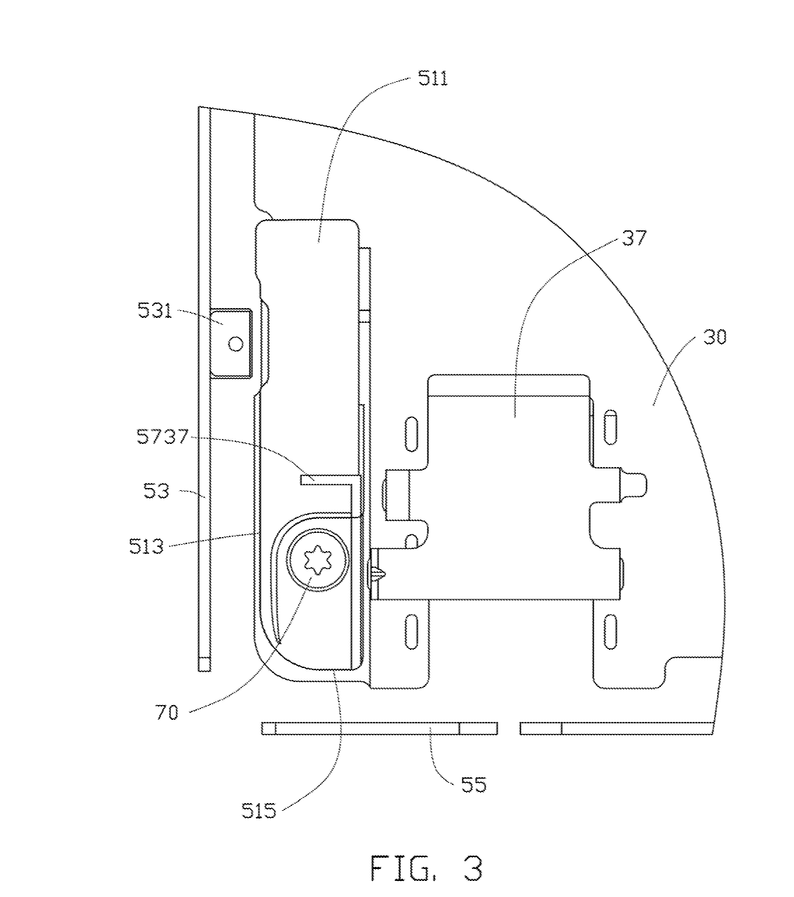

FIG. 3 illustrates that when current is input to the feed portion 571, the current flows to the connecting section 5731, the first radiating section 5733, and the second radiating section 5735, and is further grounded via the third radiating section 5737. Then, a current path is formed for receiving/sending wireless signals at a frequency of about 1.575 GHz.

By adjusting positions of the first metallic portion 53 and the second metallic portion 55 to make the distance between the first radiating section 5733 and the first metallic portion 53 and a distance between the second radiating section 5733 and the second metallic portion both to satisfy radiating standard of the antenna structure 50. Then, when the current flows through the connecting section 5731, the first radiating section 5733 is coupled with the first metallic portion 53, the second radiating section 5735 is coupled with the second metallic portion 55, and the third radiating section 5737 is coupled with the electronic element 37, so that a frequency band of the antenna structure 50 is broadened and a power of the radiating portion 573 can also be absolutely radiated.

Furthermore, due to the feed point 31 is electrically connected to the ground point 33. The current from the radiator 57 is grounded via the ground point 33 so that a strongest power of the antenna structure 50 can be focused at a top of the wireless communication device 100, which will improve a radiating performance of the antenna structure 50.

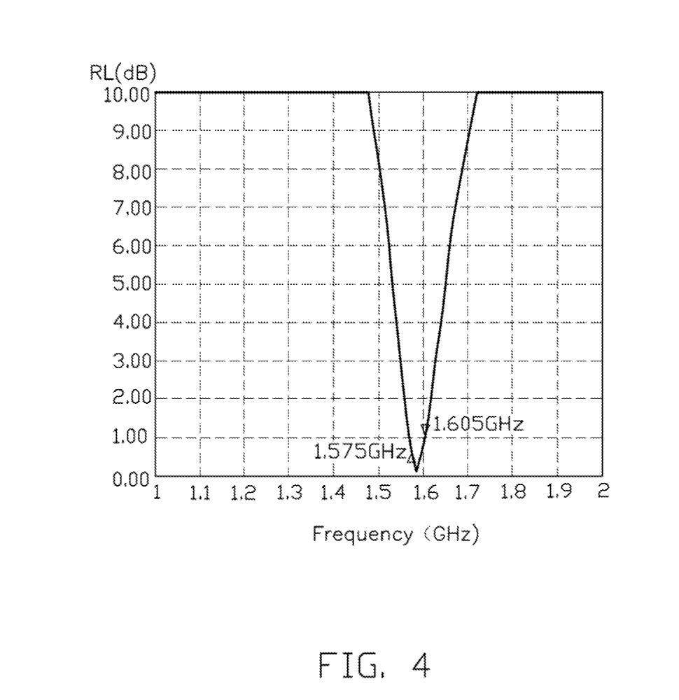

FIG. 4 illustrates a return loss (RL) measurement of the antenna structure 50. It can be derived from FIG. 4 that the antenna structure 50 and the wireless communication device 100 employing the antenna structure 50 can be utilized in common wireless communication systems, such as GPS (1.575 GHz) or GLONASS (1.605 GHz), with exceptional communication quality.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An antenna structure comprising:
an antenna holder comprising a top wall, a first sidewall, and a second sidewall, the first sidewall and the second sidewall both substantially perpendicularly connected to a periphery of the top wall;
a radiator positioned at least on the top wall, the first sidewall, and the second sidewall;
a first metallic portion substantially parallel to the first sidewall and configured for being coupled to the radiator; and
a second metallic portion substantially parallel to the second sidewall and configured for being coupled to the radiator.

2. The antenna structure of claim 1, wherein one side of the first metallic portion facing to the first sidewall forms a ground portion for grounding the first metallic portion.

3. The antenna structure of claim 1, wherein the radiator comprises a feed portion and a radiating portion, the radiating portion is electrically connected to the feed portion and forms a substantially loop structure with the feed portion.

4. The antenna structure of claim 3, wherein the antenna holder further comprises a third sidewall, the third sidewall is spaced apart from and is substantially parallel to the first sidewall, the first sidewall and the third sidewall are electrically connected to two ends of the second sidewall; the top wall, the first sidewall, the second sidewall, and the third sidewall cooperatively form a receiving space for receiving the feed portion.

5. The antenna structure of claim 4, wherein the radiating portion comprises a connecting section, a first radiating section, a second radiating section, and a third radiating section, the connecting section is electrically connected to one side of the feed portion and is received in the receiving space; the first radiating section is positioned at the first sidewall, the second radiating section is positioned at the second sidewall and is electrically connected to the first radiating section away from the connecting section; the third radiating section is positioned at the top wall and is electronically connected to the second radiating section away from the first radiating section.

6. The antenna structure of claim 5, wherein the first radiating section is substantially a strip and is parallel to the first metallic portion.

7. The antenna structure of claim 5, wherein the second radiating section is substantially a strip and is parallel to the second metallic portion.

8. The antenna structure of claim 5, wherein a distance between the first radiating section and the first metallic portion is about 2.3 mm.

9. The antenna structure of claim 5, wherein a distance between the second radiating section and the second metallic portion is about 2.3 mm.

10. A wireless communication device comprising:
a circuit board; and
an antenna structure positioned on the circuit board, the antenna structure comprising:
an antenna holder positioned at the circuit board and comprising a top wall, a first sidewall, and a second sidewall, the first sidewall and the second sidewall both substantially perpendicularly connected to a periphery of the top wall;
a radiator positioned at least on the top wall, the first sidewall, and the second sidewall;
a first metallic portion substantially parallel to the first sidewall and configured for being coupled to the radiator; and
a second metallic portion substantially parallel to the second sidewall and configured for being coupled to the radiator.

11. The wireless communication device of claim 10, wherein the circuit board forms a feed point and a ground point, the feed point is electrically connected to the radiator, and the ground point is electrically connected to the feed point.

12. The wireless communication device of claim 10, wherein the circuit board further defines a mounting hole, the top wall defines an assembling hole, and the antenna holder is mounted to the circuit board via a mounting element inserting through the assembling hole and the mounting hole.

13. The wireless communication device of claim 10, wherein one side of the first metallic portion facing to the first sidewall forms a ground portion for grounding the first metallic portion.

14. The wireless communication device of claim 10, wherein the radiator comprises a feed portion and a radiating portion, the radiating portion is electrically connected to the feed portion and forms a substantially loop structure with the feed portion.

15. The wireless communication device of claim 14, wherein the antenna holder further comprises a third sidewall, the third sidewall is spaced apart from and is substantially parallel to the first sidewall, the first sidewall and the third sidewall are electrically connected to two ends of the second sidewall; the top wall, the first sidewall, the second sidewall, and the third sidewall cooperatively form a receiving space for receiving the feed portion.

16. The wireless communication device of claim 15, wherein the circuit board further comprises an electronic element, the electronic element is positioned on an end of the circuit board adjacent to the third sidewall.

17. The wireless communication device of claim 15, wherein the radiating portion comprises a connecting section, a first radiating section, a second radiating section, and a third radiating section, the connecting section is electrically connected to one side of the feed portion and is received in the receiving space; the first radiating section is positioned at the first sidewall, the second radiating section is positioned at the second sidewall and is electrically connected to the first radiating section away from the connecting section; the third radiating section is positioned at the top wall and is electronically connected to the second radiating section away from the first radiating section.

18. The wireless communication device of claim 17, wherein the first radiating section is substantially a strip and is parallel to the first metallic portion.

19. The wireless communication device of claim 17, wherein the second radiating section is substantially a strip and is parallel to the second metallic portion.

20. The wireless communication device of claim 17, wherein a distance between the first radiating section and the first metallic portion is about 2.3 mm, and a distance between the second radiating section and the second metallic portion is about 2.3 mm.
